(19) United States
(12) Patent Application Publication
(10) Pub. No.: US 2026/0212599 A1
(43) Pub. Date: Jul. 23, 2026

(54) MESH GENERATION METHOD

(71) Applicant: Siemens Industry Software Inc., Plano, TX (US)

(72) Inventors: Matthew Goddard, Cambridge (GB); Callum Durnford, Cambridge (GB); Peter Nanson, Cambridge (GB); Alex Lyons, Cambridge (GB); Richard Collins, Cambridge (GB)

(21) Appl. No.: 19/143,238

(22) PCT Filed: Jan. 17, 2023
(86) PCT No.: PCT/US2023/010915

§ 371 Date: Jun. 25, 2025

(51) Int. Cl. G06T 17/20; G06T 17/10

(52) U.S. Cl. CPC G06T 17/20; G06T 17/10

(57) ABSTRACT

A method for generating a mesh for a lattice structure in a three-dimensional model is provided. A first mesh incarnation method is applied to a first lattice to generate a first mesh. A second lattice is extracted from the first lattice, including bodies of the first lattice in the region where the first mesh incarnation method fails to generate mesh facets. Polylines on the first mesh of the first lattice where an offset of the second lattice intersects with the first mesh are identified. A third lattice is generated based on the polylines. A second mesh incarnation method is applied to generate a first mesh of the third lattice. The first mesh of the first lattice and the first mesh of the third lattice are trimmed and combined to generate a second mesh with mesh facets in the region where the first mesh incarnation method fails to generate facets.

The present patent document is a § 371 nationalization of PCT Application Serial No. PCT/US2023/010915, filed Jan. 17, 2023, designating the United States, which is hereby incorporated by reference in its entirety.

### TECHNICAL FIELD

The present disclosure relates to a computer implemented method for generating a mesh for a lattice structure in a three-dimensional model and, in particular, a method for generating a mesh for a lattice structure using two mesh incarnation methods.

### BACKGROUND

Computer-Aided Design (CAD) systems are used in many fields of engineering, manufacturing, and design to create and manipulate solid modelling representations of objects, for example, in additive manufacturing. Boundary representation (B-rep) technology provides an efficient and adaptable representation of parts by combining meshes and classic geometry: analytic surfaces and curves, non-uniform rational basis spline (NURBS), and procedural surfaces and curves; with topology, which captures the connectivity and interaction between geometric elements. Additive manufacturing is the process of creating three-dimensional objects using a three-dimensional printer based on CAD or other digital three-dimensional models. Objects may be scanned as a precursor to creating a CAD model, or may be designed from scratch, and stored in either stereolithography (STL) file format or additive manufacturing (AMF) file format files for future printing.

Lattices are a common type of interior space-filler used in CAD systems and additive manufacturing. Lattice structures may be used for their physical and mechanical properties in, for example, heat transfer, filtration, and structural components. In Boundary Representation (B-rep) modelling, lattice structures may be enclosed by closed, connected sets of faces, where each face is a portion of a two-dimensional surface. The faces have boundary edges, which are defined by curves where the faces intersect with one another. Rod and ball lattices are lattices including a plurality of lattice topologies, where a lattice topology is either a rod or a ball. Rods may be cylindrical or conical, and balls are spherical. Each rod is joined to other rods by a ball, building up the lattice structure. The ball radii may be constant across the lattice, or vary across the entire lattice, or a combination of both. Similarly, the rods may vary in thickness linearly along their length.

A mesh is a subdivision of a continuous geometric space into discrete geometric and topological cells called facets. In modelling systems, the majority of operations are available when using a mesh structure, but this may be limited when considering a lattice structure. In order to overcome this, lattices used for space filling may be converted into meshes (to tolerance) in order to perform certain operations. Meshes are also employed in three-dimensional printing applications, hence lattice conversion is also used in additive manufacturing situations.

One method of mesh incarnation for lattices finds sets of facets for each topology in the lattice by directly using the surface geometry of the cylindrical or conical rod or for the spherical balls independently. This method, referred to herein as the analytic method, is very fast when the intersections between the topologies in the lattice are analytic curves. The resulting facet patterns are aligned to the directions of rods and facet vertices lie on the intersections between the topologies of the lattice. The curves resulting from intersecting topologies of a lattice may be non-analytic curves. For example, in self intersecting lattices curves resulting from rod-rod or rod-ball clashes may be non-analytic. The method may be extended to deal with these cases but may also become unreliable if there are a large number of near-smooth non-analytic intersections between topologies in the lattice.

In such cases, a mesh representation may be generated using a second method that combines the lattice definition of rods and balls into a single implicit function and uses the marching-cubes algorithm to find a set of facets. This second method produces a mesh regardless of the complexity of how the different topologies in the lattice interact. However, it may be slower than the first method and may give facet patterns that are not orientated in any way to the individual rods in the lattice. Furthermore, the resulting facet vertices may not lie on the intersections between topologies in the lattice.

### SUMMARY

It is an object of the disclosure to provide a method for generating a mesh for a lattice structure in a three-dimensional model.

The scope of the present disclosure is defined solely by the appended claims and is not affected to any degree by the statements within this summary. The present embodiments may obviate one or more of the drawbacks or limitations in the related art.

According to a first aspect of the disclosure, a computer-implemented method for generating a mesh for a lattice structure in a three-dimensional model is provided. The method includes: a) applying a first mesh incarnation method to a first lattice including a plurality of bodies to generate a first mesh including a plurality of mesh facets corresponding to the first lattice; b) identifying a region of the first lattice where the first mesh incarnation method fails to generate mesh facets; c) extracting a second lattice from the first lattice, the second lattice including bodies of the first lattice in the region where the first mesh incarnation method fails to generate mesh facets; d) generating an offset of the second lattice; e) identifying polylines on the first mesh of the first lattice where the offset of the second lattice intersects with the first mesh; f) generating a third lattice based on the identified polylines and associated bodies; g) applying a second mesh incarnation method to generate a first mesh of the third lattice, the second mesh incarnation method different from the first mesh incarnation method; h) trimming the first mesh of the first lattice and the first mesh of the third lattice; and i) combining, the trimmed portions of the first mesh of the first lattice and the first mesh of the third lattice to obtain a second mesh for the first lattice. The second mesh includes mesh facets in the region where the first mesh incarnation method fails to generate mesh facets.

The method according to the first aspect provides faster and better-quality results in incarnation of lattices as meshes. In particular, the method according to the first aspect combines two mesh incarnation methods into a single incarnation call. Thus, for example, the method may be used to apply marching cubes incarnation locally for regions where the analytic method has failed to find mesh facets. The method is faster than applying a marching cubes method globally to the whole lattice.

According to a second aspect of the disclosure, a computer program is provided. The computer program includes code, which when executed by a data processing system causes the data processing system to carry out the acts of the method according to the first aspect.

In a first implementation form of the method according to the first aspect, the third lattice includes bodies of the second lattice and bodies of the first lattice associated with the polylines on the first mesh.

In a second implementation form, the third lattice includes bodies of the first lattice that are traversed to identify the polylines and bodies of the first lattice within a pre-determined distance of the polylines.

In a third implementation form, the pre-determined distance is proportional to a voxel resolution.

In a fourth implementation form, the first mesh incarnation method includes identifying facets on surfaces of the bodies of the first lattice.

In a fifth implementation form, the second mesh incarnation method is a marching cubes method.

In a sixth implementation form, the identifying of a region of the first lattice where the first mesh incarnation method fails to generate mesh facets includes: identifying bodies of the first lattice where the first mesh incarnation method fails to generate mesh facets on the basis of an identification of the bodies of the first lattice; and determining the bodies of the first lattice where the mesh incarnation method successfully generates mesh facets.

In a seventh implementation form, the identifying of polylines on the first mesh of the first lattice where the offset of the second lattice intersects with the first mesh includes: constructing an implicit function of the offset of the second lattice; and determining polylines on the first mesh of the first lattice based on an evaluation of the implicit function on the first mesh.

In an eighth implementation form, the method further includes: identifying one or more regions where polylines on the first mesh of the first lattice do not correspond to polylines on the first mesh of the third lattice; modifying the implicit function in one or more localized regions of the second lattice; and determining further polylines on the first mesh of the first lattice based on an evaluation of the modified implicit function on the first mesh of the first lattice.

In a ninth implementation form, the method further includes identifying the corresponding polylines on the first mesh of the third lattice from the further polylines on the first mesh of the first lattice.

In a tenth implementation form, the lattice includes a rod and ball lattice.

In an eleventh implementation form, the lattice includes a generalized pattern of a cell body.

In a twelfth implementation form, the second mesh includes mesh facets in regions where the first mesh incarnation method generates mesh facets.

These and other aspects of the disclosure become apparent from the embodiments described below.

### BRIEF DESCRIPTION OF THE DRAWINGS

For a more complete understanding of the present disclosure, and the advantages thereof, reference is now made to the following descriptions taken in conjunction with the accompanying drawings.

FIG. 1a shows a schematic perspective illustration of a rod and ball, according to an example.

FIG. 1b shows a schematic perspective illustration of a rod and ball, according to an example.

FIG. 2 shows a schematic perspective illustration of a portion of a mesh representation of a lattice, according to an example.

FIG. 3a shows a schematic perspective illustration of an offset of a lattice, according to an example.

FIG. 3b shows a schematic perspective illustration of a portion of a mesh representation of a lattice, according to an example.

FIG. 4a shows a schematic perspective illustration of a lattice, according to an example.

FIG. 4b shows a schematic perspective illustration of a mesh representation of a lattice, according to an example.

FIG. 4c shows a schematic perspective illustration of a portion of a mesh representation of a lattice, according to an example.

FIG. 4d shows a schematic perspective illustration of portions of a mesh representation of a lattice, according to an example.

FIG. 5a shows a schematic perspective illustration of a portion of a mesh representation of a lattice, according to an example.

FIG. 5b shows a schematic perspective illustration of an offset of a lattice, according to an example.

FIG. 5c shows a schematic perspective illustration of a portion of a mesh representation of a lattice, according to an example.

FIG. 5d shows a schematic perspective illustration of a portion of a mesh representation of a lattice, according to an example.

FIG. 5e shows a schematic perspective illustration of a portion of a mesh representation of a lattice, according to an example.

FIG. 5f shows a schematic perspective illustration of a portion of a mesh representation of a lattice, according to an example.

FIG. 6 is a flow chart illustrating methods in accordance with various embodiments of the present disclosure.

FIG. 7 is a schematic representation of a data-processing system configured to carry out the embodiments of the present disclosure.

### DETAILED DESCRIPTION

Example embodiments are described below in sufficient detail to enable those of ordinary skill in the art to embody and implement the systems and processes described herein. It is important to understand that embodiments may be provided in many alternate forms and may not be construed as limited to the examples set forth herein.

Accordingly, while embodiments may be modified in various ways and take on various alternative forms, specific embodiments thereof are shown in the drawings and described in detail below as examples. There is no intent to limit the particular forms disclosed. On the contrary, all modifications, equivalents, and alternatives falling within the scope of the appended claims may be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document may not preclude the presence of more than one referent. In other words, elements referred to in the singular may number one or more, unless the context clearly indicates otherwise. The terms “comprises,” “comprising,” “includes,” and/or “including,” when used herein, specify the presence of stated features, items, acts, operations, elements, and/or components, but do not preclude the presence or addition of one or more other features, items, acts, operations, elements, components, and/or groups thereof.

Unless otherwise defined, all terms (including technical and scientific terms) used herein are to be interpreted as is customary in the art. The terms in common usage may also be interpreted as is customary in the relevant art and not in an idealized or overly formal sense unless expressly so defined herein.

The embodiments described herein enable the incarnation of a lattice as a mesh using a combined approach using the first method previously described, herein referred to as the analytic method in which facets are found directly for the surface geometry of the rods and balls by using the analytic intersections between rods and balls and the second method, herein referred to as the marching cubes method, in which facets are found using a marching cubes algorithm.

The analytic method proceeds by first finding facets for all the rods of the lattice and then for all the balls. The facets are assembled into a mesh. When the analytic method fails to find any facets for a rod or a ball, the rod or ball is identified as “failed.” Facets are found for the remaining rods and balls. A rod that has been identified as “failed” prevents the method from finding facets for any of the balls that interact with the rod. Therefore, if a rod is identified as “failed,” then balls that interact with that rod are also identified as “failed.” In some cases, the mesh may be disjoint.

Subsequently, the marching cubes method is applied to a smaller lattice including the failed rods and balls as well as the rods and balls that surround the failed rods and balls. This results in two meshes: one from the incarnation of the lattice using the analytic method and one from the incarnation of the smaller lattice using the marching cubes method. A portion of the smaller marching cubes mesh is then used to patch the large mesh in regions where the analytic method failed to find facets.

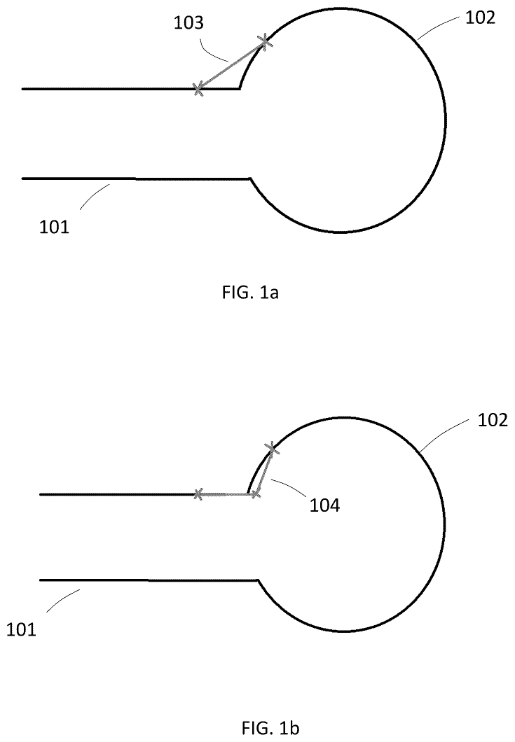

Determining where to trim the marching cubes mesh to match it with the larger mesh requires finding suitable sets of pairs of polylines on the two meshes. Each pair includes one polyline that lies on the analytic mesh and one polyline that lies on the marching-cubes mesh. The two polylines may be well matched in the sense of not being far apart and lying approximately in the same direction. It is possible to use the edges of the facets surrounding a region where the analytic method has failed to find facets as polylines on the analytic mesh. Unfortunately, this does not result in a good match with polylines on the marching cubes mesh. This is because regions where the analytic method fails to find facets may be at sharp edges of the lattice. The behavior of the marching-cubes algorithm around these sharp edges may have a chamfering effect on the edge. This results in a poor match with the analytic mesh. FIGS. 1a and 1b show examples of this chamfering effect at an interface of a rod 101 and ball 102. Facet edges 103, 104 resulting from the marching cubes algorithm chamfer the edge 105.

To address this, in the method described herein a set of polyline pairs is obtained by stepping back into the rods surrounding the region where the analytic method fails to identify facets.

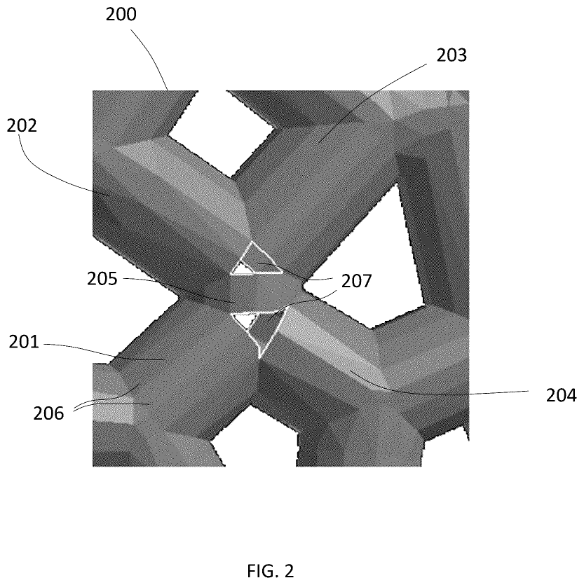

FIG. 2 is a schematic perspective illustration of a portion of a first rod and ball lattice that has been incarnated as a first mesh 200, according to an example. The portion of the first lattice includes rods 201, 202, 203, 204, 205. Each rod also includes spherical balls at each end of the rod. In the example shown in FIG. 2, the first lattice is incarnated as the first mesh 200 using the analytic method previously described. As may be seen in FIG. 2, (for example, on the rod 201), the mesh facets 206 of the first mesh 200 are aligned to the direction of the rod 201 and facet edges lie on the intersection between the rod 201 and the surrounding rods. In the regions 207, the rods intersect and create an area with many overlapping rods and balls in which the analytic method has failed to find mesh facets.

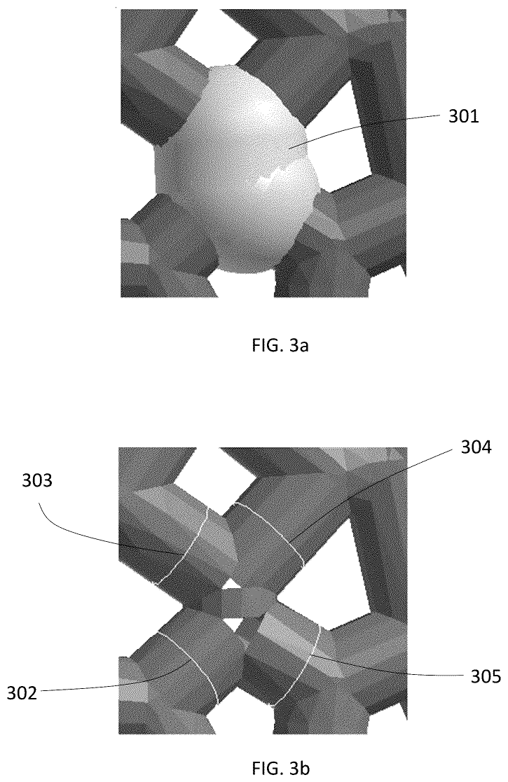

FIGS. 3a and 3b show schematic perspective illustrations of the same portion of the first lattice shown in FIG. 2. A second lattice is constructed from the first lattice including all the bodies identified as “failed” bodies in the first lattice. In some cases, the second lattice may be disjoint. An offset 301 proportional to the voxel resolution is applied to the second lattice. In FIG. 3b, polylines 302, 303, 304, 305 are polylines that approximate the intersection of the offset 301 with the first mesh.

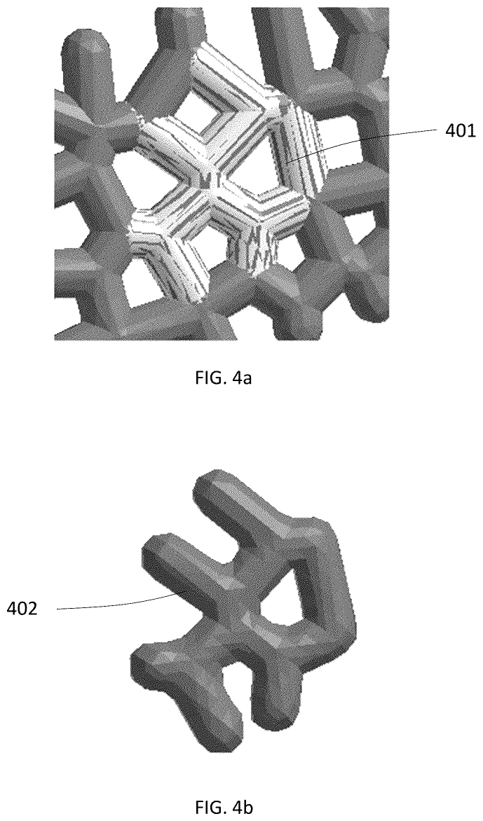

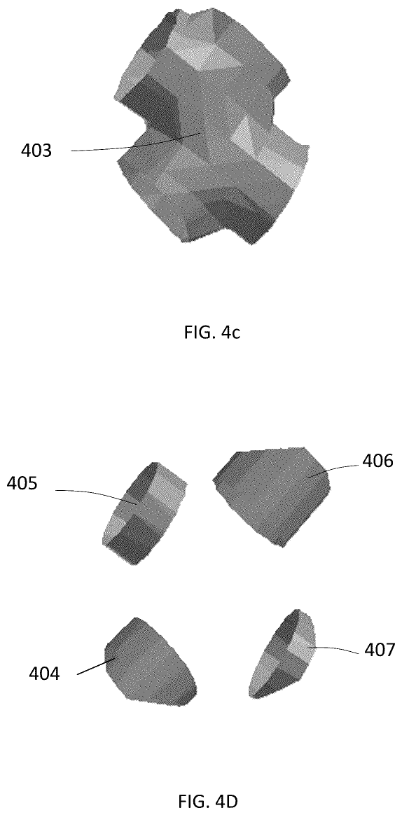

FIG. 4a shows a schematic perspective illustration of a portion of the first lattice. In FIG. 4a, a third lattice 401 is generated on the basis of the identified polylines 302, 303, 304, 305 and the bodies of the first lattice associated to the polylines 302, 303, 304, 305. The third lattice 401 includes bodies of the second lattice, i.e., the “failed” bodies, and bodies of the first lattice associated with polylines 302, 303, 304, 305. In some examples, the third lattice may be volumetrically disjoint. In this case, the third lattice is split up into multiple lattices.

In the example shown in FIG. 4a, the set of bodies associated with polylines includes the rods 201, 202, 203, 204, 205 and balls at the intersections of these rods. The bodies associated with polylines also include any bodies of the first lattice that are traversed to identify the polylines 302, 303, 304, 305 and bodies of the first lattice within a pre-determined distance of the polylines 302, 303, 304, 305. The pre-determined distance may be a value proportional to the voxel resolution. A pre-determined distance equal to five times voxel resolution provides sufficient space in case adjustments are made to polyline segments to avoid a problematic area of the lattice at a later stage. In the third lattice 401, in addition to rods 201, 202, 203, 204, 205 and their associated balls, the bodies lying within a pre-determined distance include all the highlighted rods and balls shown in FIG. 4a.

The bodies that lie within the pre-determined distance of a polyline may be identified by constructing a lattice including a set of cylindrical rods with axes that are along the polyline chords, and radii equal to the pre-determined distance. This lattice may be clashed with the first lattice to find bodies in the first lattice within the pre-determined distance.

FIG. 4b shows a schematic perspective illustration of the third lattice 401 incarnated as a mesh 402. In FIG. 4b, the third lattice 4b is incarnated using the marching cubes algorithm. In its simple form the marching cubes algorithm creates a mesh from an implicit function over a uniform grid of cubes superimposed over a region of the function. In the present case, an implicit function for the third lattice 401 is constructed and the marching cubes algorithm is applied to this implicit function to generate the mesh 402.

Once the marching cubes mesh 402 has been generated a portion of the mesh is extracted to patch the mesh 200. As previously discussed, this requires finding approximately matching pairs of polylines on the two meshes. For each segment of polylines 302, 303, 304, 305, a direction in which to project points of the segment from the mesh 200 to the 402 is determined. In places where a local region around the point lies in a single lattice body, the direction of projection onto the marching cubes may be taken to be the body normal direction. In regions where a point is near more than one lattice body, the direction of projection is taken to be a weighted average of the normal directions of the bodies near the point. Alternatively, the projection direction may be based on a weighted average of facet normal directions in the region. This avoids discontinuities in the normal direction and provides a smooth mapping of points from the polyline on the mesh 200 to the mesh 402.

FIG. 4c shows a schematic perspective illustration of a portion 403 of the mesh 402. The portion 403 is extracted from the mesh 402 by trimming the mesh 402 along the projections of the polylines 302, 303, 304, 305. FIG. 4d shows portions 404, 405, 406, 407 of the first mesh. These portions include trimmed portions of the first mesh for bodies of the first lattice surrounding the boundary of the portion 403 of mesh 402. The trimmed portions 404, 405, 406, 407 are combined with portion 403 to obtain a patched mesh for the first lattice, with mesh facets in the regions 207.

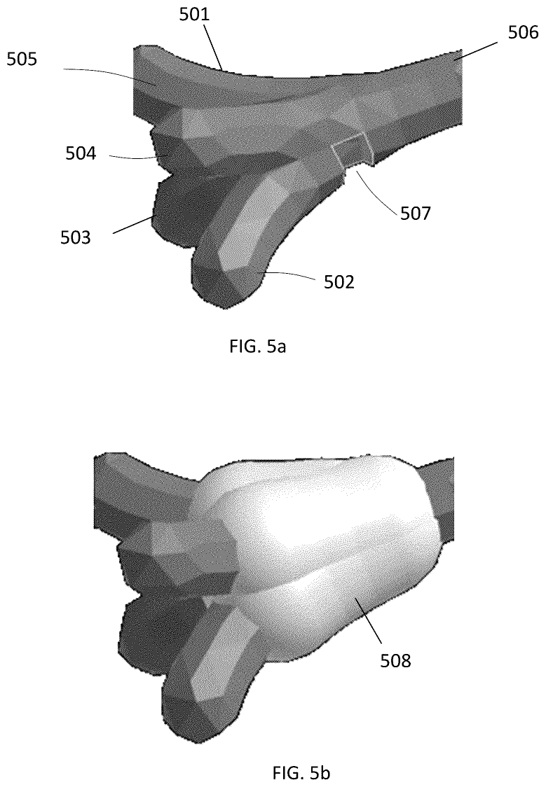

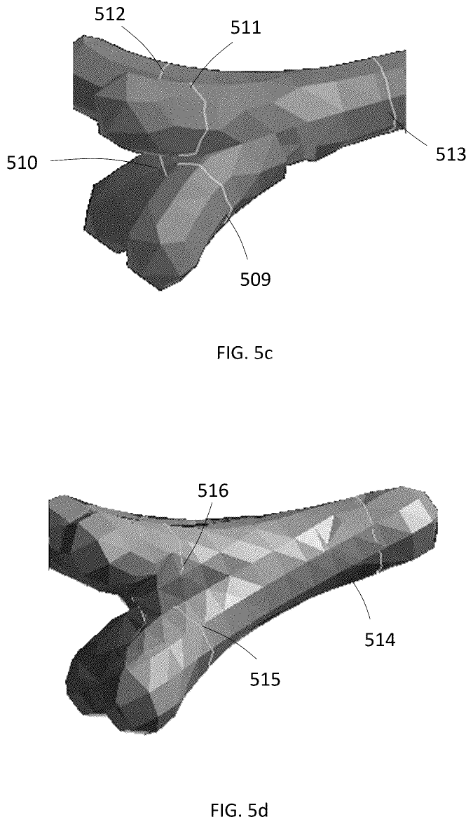

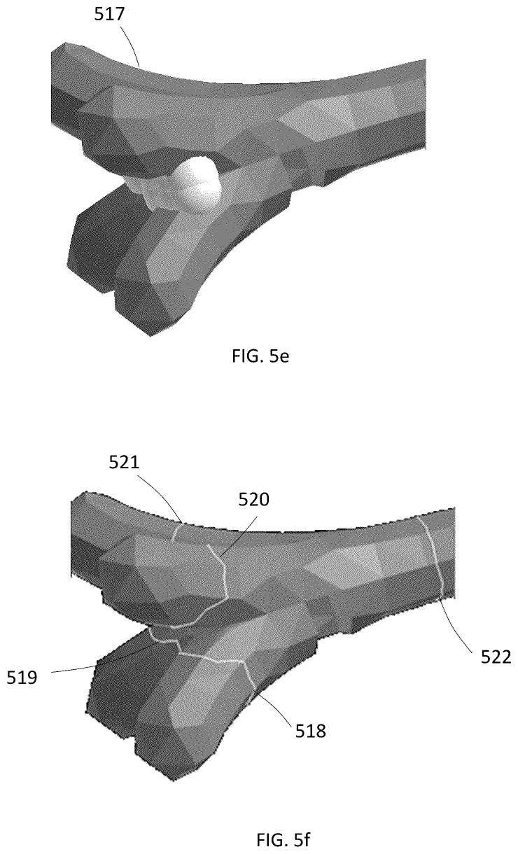

In some lattices, the polylines obtained from intersecting the offset of the second lattice may produce undesirable results when projected onto the mesh generated from the marching cubes algorithm. FIG. 5a is a schematic perspective illustration of a portion of a lattice. In FIG. 5a, the portion is represented as a mesh 501 that is obtained from applying the analytic method to the lattice. The lattice portion includes an intersection of rods 502, 503, 504, 505, 506. In the region 507, the analytic method has failed to find any facets. Following the method previously described, a second lattice is extracted from the first lattice. The second lattice includes the failed bodies identified from the first lattice. FIG. 5b is a schematic perspective illustration showing an offset 508 of the second lattice. FIG. 5c is a schematic perspective illustration showing polylines 509, 510, 511, 512, 513, which are obtained by intersecting the offset 508 with the mesh 501.

FIG. 5d is a schematic perspective illustration showing the projections of the polylines 509, 510, 511, 512, 513 onto a mesh 514 obtained from application of the marching cubes algorithm. As may be seen in FIG. 5d from the projections 515, 516 of polylines 509, 511, the polylines have not projected cleanly onto the mesh 514. This is because the offset 508 is too close to the intersection of the rods 502, 503, 504, 505, 506.

FIG. 5e is a schematic perspective illustration showing a modified lattice 517. This is generated by modifying the implicit lattice definition to include additional rods of width equal to voxel resolution. This allows the polylines 509, 510, 511, 512, 513 to be diverted away from problematic area resulting in polylines 518, 519, 520, 521, 522 shown in FIG. 5f.

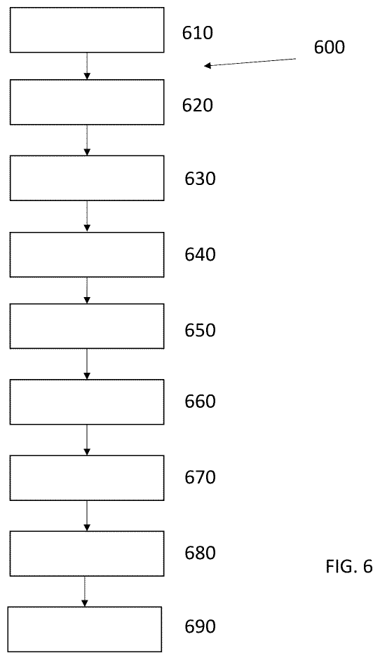

FIG. 6 shows a flow diagram of a method 600 for generating a mesh for a lattice structure in a three-dimensional model, according to an example. The method 600 may be applied to the lattices described herein. The method may be implemented in conjunction with methods and examples described herein.

At block 610, the method 600 includes applying a first mesh incarnation method to a first lattice including a plurality of bodies to generate a first mesh including a plurality of mesh facets corresponding to the first lattice. According to examples, the first mesh incarnation method is an analytic method including identifying facets on the surface of the bodies of the first lattice.

At block 620, the method 600 includes identifying a region of the first lattice where the first mesh incarnation method fails to generate mesh facets. In some cases, identifying a region of the first lattice where the first mesh incarnation method fails to generate mesh facets includes identifying bodies of the first lattice where the first mesh incarnation method fails to generate mesh facets on the basis of an identification of the bodies of the first lattice and a determination of the bodies of the first lattice where the mesh incarnation method successfully generates mesh facets.

At block 630, the method 600 includes extracting a second lattice from the first lattice. The second lattice includes bodies of the first lattice in the region where the first mesh incarnation method fails to generate mesh facets.

At block 640, the method 600 includes generating an offset of the second lattice. The offset of the second lattice may be within a pre-determined distance of the first lattice. The pre-determined distance may be proportional to a voxel resolution.

At block 650, the method 600 includes identifying polylines on the first mesh of the first lattice where the offset of the second lattice intersects with the first mesh. In some cases, identifying polylines on the first mesh of the first lattice where the offset of the second lattice intersects with the first mesh includes constructing an implicit function of the offset of the second lattice and determining polylines on the first mesh of the first lattice based on an evaluation of the implicit function on the first mesh.

At block 660, the method 600 includes generating a third lattice based on the identified polylines and associated bodies. According to examples, the third lattice includes bodies of the second lattice and bodies of the first lattice associated with the polylines on the first mesh. In some cases, the third lattice includes bodies of the first lattice which are traversed to identify the polylines and bodies of the first lattice within a pre-determined distance of the polylines. The pre-determined distance may be proportional to a voxel resolution.

At block 670, the method 600 includes applying a second mesh incarnation method to generate a first mesh of the third lattice where the second mesh incarnation method is different from the first mesh incarnation method. In examples described herein, the second mesh incarnation method is a marching cubes algorithm.

At block 680, the method 600 includes trimming the first mesh of the first lattice and the first mesh of the third lattice. According to examples, the trimming of the first mesh of the first lattice and the first mesh of the third lattice is based on an identification of polylines on the first mesh of the third lattice, corresponding to polylines on the first mesh of the first lattice.

At block 690, the method 600 includes combining the trimmed portions of the first mesh of the first lattice and the first mesh of the third lattice to obtain a second mesh for the first lattice. The second mesh includes mesh facets in the region where the first mesh incarnation method fails to generate mesh facets as well as mesh facets in the other regions where the first mesh incarnation method found mesh facets.

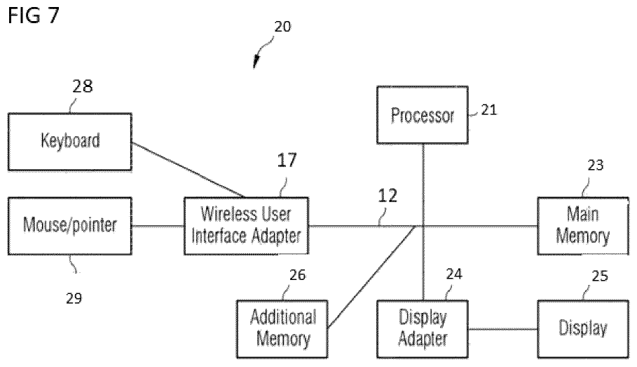

FIG. 7 illustrates an example of a data processing system in which an embodiment of the present disclosure may be implemented, for example, a CAD system configured to perform processes as described herein. The data processing system 20 includes a processor 21 connected to a local system bus 22. The local system bus connects the processor to a main memory 23 and graphics display adaptor 24, which may be connected to a display 25. The data processing system may communicate with other systems via a wireless user interface adapter connected to the local system bus 22, or via a wired network, for example, to a local area network. Additional memory 16 may also be connected via the local system bus. A suitable adaptor, such as wireless user interface adapter 27, for other peripheral devices, such as a keyboard 28 and mouse 29, or other pointing device, allows the user to provide input to the data processing system. Other peripheral devices may include one or more I/O controllers such as USB controllers, Bluetooth controllers, and/or dedicated audio controllers (connected to speakers and/or microphones). Various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further, certain devices referred to as input devices or output devices may both provide inputs and receive outputs of communications with the data processing system. Further, other peripheral hardware connected to the I/O controllers may include any type of device, machine, or component configured to communicate with a data processing system.

An operating system included in the data processing system enables an output from the system to be displayed to the user on display 25 and the user to interact with the system. Examples of operating systems that may be used in a data processing system may include Microsoft Windows™, Linux™, UNIX™, iOS™, and Android™ operating systems.

In addition, the data processing system 20 may be implemented as in a networked environment, distributed system environment, virtual machines in a virtual machine architecture, and/or cloud environment. For example, the processor 11 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 20 may vary for particular implementations. For example, the data processing system 20 in this example may correspond to a computer, workstation, and/or a server. However, alternative embodiments of a data processing system may be configured with corresponding or alternative components such as in the form of a mobile phone, tablet, controller board, or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 20 may be connected to the network (not a part of data processing system 20), which may be any public or private data processing system network or combination of networks, as known to those of skill in the art, including the Internet. Data processing system 20 may communicate over the network with one or more other data processing systems such as a server (also not part of the data processing system 20). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, when referring to a data processing system, such a system may be implemented across several data processing systems organized in a distributed system in communication with each other via a network.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for generating a mesh for a lattice structure in a three-dimensional model, the computer-implemented method comprising:
applying a first mesh incarnation method to a first lattice comprising a plurality of bodies to generate a first mesh comprising a plurality of mesh facets corresponding to the first lattice;
identifying a region of the first lattice where the first mesh incarnation method fails to generate mesh facets;
extracting a second lattice from the first lattice, the second lattice comprising bodies of the first lattice in the region where the first mesh incarnation method fails to generate mesh facets;
generating an offset of the second lattice;
identifying polylines on the first mesh of the first lattice where the offset of the second lattice intersects with the first mesh of the first lattice;
generating a third lattice based on the polylines and associated bodies;
applying a second mesh incarnation method to generate a first mesh of the third lattice, wherein the second mesh incarnation method is different from the first mesh incarnation method;
trimming the first mesh of the first lattice and the first mesh of the third lattice to provide trimmed portions of the first mesh of the first lattice and trimmed portions of the first mesh of the third lattice; and
combining the trimmed portions of the first mesh of the first lattice and the trimmed portions of the first mesh of the third lattice to obtain a second mesh for the first lattice,
wherein the second mesh comprises mesh facets in the region where the first mesh incarnation method fails to generate mesh facets.

2. The computer-implemented method of claim 1, wherein the third lattice comprises:
bodies of the second lattice; and
bodies of the first lattice associated with the polylines on the first mesh.

3. The computer-implemented method of claim 2, wherein the third lattice comprises:
bodies of the first lattice that are traversed to identify the polylines; and
bodies of the first lattice within a pre-determined distance of the polylines.

4. The computer-implemented method of claim 3, wherein the pre-determined distance is proportional to a voxel resolution.

5. The computer-implemented method of claim 1, wherein the first mesh incarnation method comprises identifying facets on surfaces of the bodies of the first lattice.

6. The computer-implemented method of claim 1, wherein the second mesh incarnation method is a marching cubes method.

7. The computer-implemented method of claim 1, wherein the identifying of the region of the first lattice where the first mesh incarnation method fails to generate mesh facets comprises:
identifying bodies of the first lattice where the first mesh incarnation method fails to generate mesh facets based on an identification of the bodies of the first lattice and a determination of the bodies of the first lattice where the first mesh incarnation method successfully generates mesh facets.

8. The computer-implemented method of claim 1, wherein the identifying of the polylines comprises:
constructing an implicit function of the offset of the second lattice; and
determining the polylines on the first mesh of the first lattice based on an evaluation of the implicit function on the first mesh.

9. The computer-implemented method of claim 8, further comprising:
identifying one or more regions where the polylines on the first mesh of the first lattice do not correspond to polylines on the first mesh of the third lattice;
modifying the implicit function in one or more localized regions of the second lattice to provide a modified implicit function; and
determining further polylines on the first mesh of the first lattice based on an evaluation of the modified implicit function on the first mesh of the first lattice.

10. The computer-implemented method of claim 9, further comprising:
identifying the corresponding polylines on the first mesh of the third lattice from the further polylines on the first mesh of the first lattice.

11. The computer-implemented method of claim 1, wherein the first lattice is a rod and ball lattice.

12. The computer-implemented method of claim 1, wherein the first lattice comprises a pattern of a cell body.

13. The computer-implemented method of claim 1, wherein the second mesh comprises mesh facets in regions where the first mesh incarnation method generates mesh facets.

14. A computer program comprising code, which when executed by a data processing system, causes the data processing system to:
apply a first mesh incarnation method to a first lattice comprising a plurality of bodies to generate a first mesh comprising a plurality of mesh facets corresponding to the first lattice;
identify a region of the first lattice where the first mesh incarnation method fails to generate mesh facets;
extract a second lattice from the first lattice. the second lattice comprising bodies of the first lattice in the region where the first mesh incarnation method fails to generate mesh facets;
generate an offset of the second lattice;
identify polylines on the first mesh of the first lattice where the offset of the second lattice intersects with the first mesh of the first lattice;
generate a third lattice based on the polylines and associated bodies;
apply a second mesh incarnation method to generate a first mesh of the third lattice, wherein the second mesh incarnation method is different from the first mesh incarnation method;
trim the first mesh of the first lattice and the first mesh of the third lattice to provide trimmed portions of the first mesh of the first lattice and trimmed portions of the first mesh of the third lattice; and
combine the trimmed portions of the first mesh of the first lattice and the trimmed portions of the first mesh of the third lattice to obtain a second mesh for the first lattice,
wherein the second mesh comprises mesh facets in the region where the first mesh incarnation method fails to generate mesh facets.
